(19) United States
(12) Patent Application Publication
(10) Pub. No.: US 2023/0392652 A1
(43) Pub. Date: Dec. 7, 2023

(54) FRICTION PAD, ASSEMBLY, AND METHOD OF MAKING AND USING THE SAME

(71) Applicant: SAINT-GOBAIN PERFORMANCE PLASTICS CORPORATION, Solon, OH (US)

(72) Inventor: Jian MA, Shanghai (CN)

(21) Appl. No.: 18/328,391

(22) Filed: Jun. 2, 2023

(30) Foreign Application Priority Data
Jun. 2, 2022 (CN) 202210632042.1

(51) Int. Cl. F16D 13/74; F16D 13/64

(52) U.S. Cl. CPC F16D 13/74; F16C 2208/00; F16D 13/64

(57) ABSTRACT

A friction pad including a friction pad body including an annular base defining an aperture down a central axis, and first and second opposing major surfaces, where the friction pad body includes a low friction material, and where at least one of the major surfaces includes a plurality of grooves adapted to retain lubricant.

### CROSS-REFERENCE TO RELATED APPLICATIONS

This application claims priority to and the benefit of Chinese Patent Application No. 202210632042.1, filed on Jun. 2, 2022, by Jian M A, entitled “FRICTION PAD, ASSEMBLY, AND METHOD OF MAKING AND USING THE SAME,” the disclosure of which is assigned to the current assignee hereof and incorporated herein by reference in its entirety for all purposes.

### FIELD OF THE DISCLOSURE

The present disclosure relates to friction pads, and more particularly to friction pads installed in assemblies such as, but not limited to, friction assemblies.

### RELATED ART

A friction pad, which is normally used to generate certain frictional torque between neighboring components, may be disposed within friction assemblies, such as, but not limited to, spindle drives for vehicles. However, achieving and maintaining desired frictional torque within a friction assembly remains elusive. Therefore, there continues to be a need for friction pads that provide desired frictional torque performance over the lifetime of friction assemblies.

### BRIEF DESCRIPTION OF THE DRAWINGS

Embodiments are illustrated by way of example and are not limited in the accompanying figures.

FIG. 1 includes a method of producing a friction pad in accordance with an embodiment;

FIG. 2A includes a cross-sectional view of a friction pad in accordance with an embodiment;

FIG. 2B includes a cross-sectional view of a friction pad in accordance with an embodiment;

FIG. 2C includes a cross-sectional view of a friction pad in accordance with an embodiment;

FIG. 2D includes a cross-sectional view of a friction pad in accordance with an embodiment;

FIG. 3A is a diagrammatic view showing the shape line of the surface of a low friction material for a friction pad according to the embodiment;

FIG. 3B is a diagrammatic view showing a simplified version of the shape line shown in FIG. 3A for the sake of illustration;

FIG. 3C is a diagrammatic view showing straight lines that connect the bottoms of recesses and the apexes of protrusions to each other along the shape line shown in FIG. 3A;

FIG. 4A includes a top view of a friction pad in accordance with an embodiment;

FIG. 4B includes a top view of a friction pad in accordance with an embodiment;

FIG. 4C includes a top view of a friction pad in accordance with an embodiment;

FIG. 4D includes a cross sectional view of a friction pad in accordance with an embodiment;

FIG. 5A includes a top view of a friction pad within an assembly in accordance with an embodiment;

FIG. 5B includes a cross-sectional view of a friction pad within an assembly in accordance with an embodiment;

FIG. 6A includes a graph of frictional torque variation versus number of total rotations for friction pad within an assembly in accordance with an embodiment;

FIG. 6B includes a graph of frictional torque variation versus number of total rotations for friction pad within an assembly in accordance with an embodiment;

FIG. 7 includes a method in accordance with an embodiment.

FIG. 8 includes a torque variation curve as a function of number of total rotations for a friction pad in an assembly in accordance with an embodiment.

FIG. 9 includes a torque variation curve as a function of number of total rotations for a friction pad in an assembly in accordance with an embodiment.

FIG. 10 includes a torque variation curve as a function of time at a certain temperature for a friction pad in an assembly in accordance with an embodiment.

FIG. 11 includes a torque variation curve as a function of time at a certain temperature for a friction pad in an assembly in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the friction pad and friction pad assembly arts.

Embodiments described herein are generally directed to a friction pad and methods of creating and using a friction pad within an assembly. In particular embodiments, the friction pad may have an annular base defining an aperture down a central axis, and first and second opposing major surfaces, where the friction pad body includes a low friction material, and where at least one of the major surfaces includes a plurality of grooves adapted to retain lubricant.

For purposes of illustration, FIG. 1 includes a diagram showing a forming process 10 for forming a friction pad. The forming process 10 may include a first step 12 of providing a base material, optionally a second step 14 of coating the base material with a low friction coating to form a composite material, and a third step 16 of forming the substrate or composite material into a friction pad.

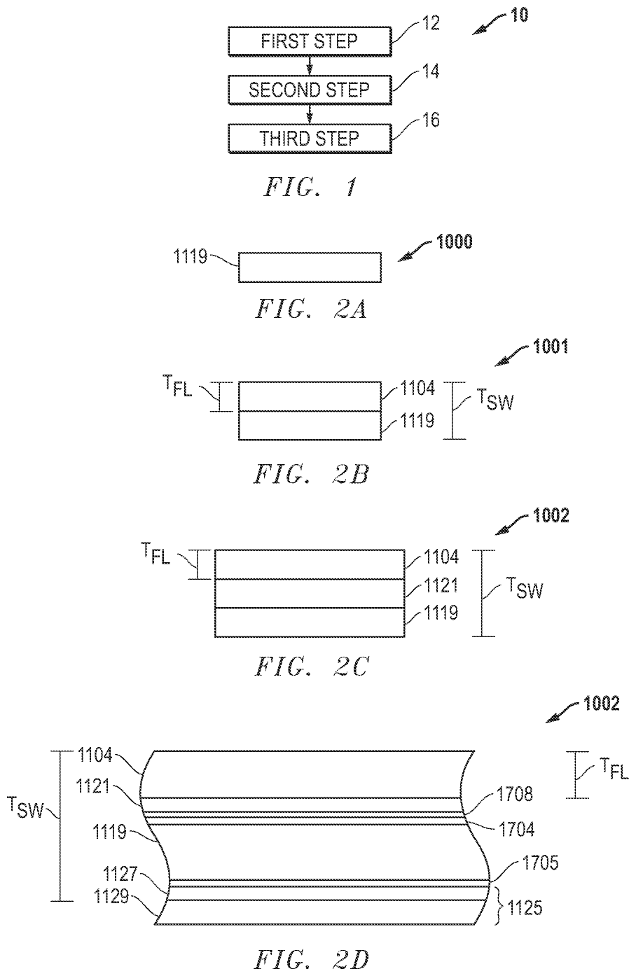

In some embodiments, FIG. 2A includes an illustration of the base material 1000 that may be formed according to first step 12 of the forming process 10. Referring to the first step 12, the base material 1000 may be a substrate 1119. In an embodiment, the substrate 1119 can at least partially include a metal. According to certain embodiments, the metal may include iron, copper, titanium, tin, aluminum, alloys thereof, or may be another type of material. More particularly, the substrate 1119 can at least partially include a steel, such as, a stainless steel, carbon steel, or spring steel. For example, the substrate 1119 can at least partially include a 301 stainless steel. The 301 stainless steel may be annealed, ¼ hard, ½ hard, ¾ hard, or full hard. The substrate 1119 may include a woven mesh or an expanded metal grid. Alternatively, the woven mesh can be a woven polymer mesh. In an alternate embodiment, the substrate 1119 may not include a mesh or grid. In an embodiment, the substrate 1119 can at least partially include a polymer. According to certain embodiments, the metal may include iron, copper, titanium, tin, aluminum, alloys thereof, or may be another type of material. More particularly, the substrate 1119 can at least partially include a steel, such as, a stainless steel, carbon steel, or spring steel. For example, the substrate 1119 can at least partially include a 301 stainless steel. The 301 stainless steel may be annealed, ¼ hard, ½ hard, ¾ hard, or full hard. The substrate 1119 may include a woven mesh or an expanded metal grid. Alternatively, the woven mesh can be a woven polymer mesh. In an alternate embodiment, the substrate 1119 may not include a mesh or grid.

In an embodiment, the substrate 1119 may include a polymer which may be selected from the group including a polyketone, a polyaramid, a polyphenylene sulfide, a polyethersulfone, a polypheylene sulfone, a polyamideimide, ultra high molecular weight polyethylene, a fluoropolymer, a polybenzimidazole, a polyacetal, polybutylene terephthalate (PBT), polypropylene (PP), polycarbonate (PC), Acrylonitrile butadiene styrene (ABS), polyethylene terephthalate (PET), a polyimide (PI), polyetherimide, polyetheretherketone (PEEK), polyethylene (PE), a polysulfone, a polyamide (PA), polyphenylene oxide, polyphenylene sulfide (PPS), a polyurethane, a polyester, a liquid crystal polymer (LCP), or any combination thereof. In a particular embodiment, the substrate 1119 can at least partially include, or even consist essentially of, a fluoropolymer. Exemplary fluoropolymers include a polytetrafluoroethylene (PTFE), a polyether ether ketone (PEEK), a polyimide (PI), a polyamide-imide (PAI), a fluorinated ethylene propylene (FEP), a polyvinylidene fluoride (PVDF), a perfluoroalkoxy (PFA), a terpolymer of tetrafluoroethylene, a hexafluoropropylene and vinylidene fluoride (THV), a polychlorotrifluoroethylene (PCTFE), an ethylene tetrafluoroethylene copolymer (ETFE), an ethylene chlorotrifluoroethylene copolymer (ECTFE), or any combination thereof. Other fluoropolymers, polymers, and blends may be included in the composition of the jacket 100. In another particular embodiment, the substrate 1119 can at least partially include, or even consist essentially of, a polyethylene (PE) such as an ultra-high-molecular-weight polyethylene (UHMWPE). In a particular embodiment, the substrate 1119 may include or consist entirely of polyetheretherketone (PEEK). In a number of embodiments, the substrate 1119 may include a low friction material as described in further detail below.

In an embodiment, the substrate 1119 may include a ceramic which may be selected from the group including a glass filler, silica, clay mica, kaolin, lithium soap, graphite, boron nitride, molybdenum disulfide, tungsten disulfide, polytetrafluoroethylene, carbon nitride, tungsten carbide, or diamond like carbon. In a number of embodiments, the friction pad may include only the substrate. In other words, the friction pad may include the substrate, which is then formed into the friction pad as described below.

In some embodiments, FIG. 2B includes an illustration of the composite material 1001 that may be formed according to first step 12 and second step 14 of the forming process 10. For purposes of illustration, FIG. 2B shows the layer by layer configuration of a composite material 1001 after second step 14. In a number of embodiments, the composite material 1001 may include a substrate 1119 (i.e., the base material provided in the first step 12) and a low friction layer 1104 (i.e., the low friction coating applied in second step 14). As shown in FIG. 2A, the low friction layer 1104 can be coupled to or disposed on at least a portion of the substrate 1119. In a particular embodiment, the low friction layer 1104 can be coupled to or disposed on a surface of the substrate 1119 so as to form a low friction interface with another surface of another component. The low friction layer 1104 can be coupled to or disposed on the radially inner surface of the substrate 1119 so as to form a low friction interface with another surface of another component. The low friction layer 1104 can be coupled to or disposed on the radially outer surface of the substrate 1119 so as to form a low friction interface with another surface of another component.

In a number of embodiments, the low friction layer 1104 can include a low friction material. Low friction materials may include, for example, a polymer, such as a polyketone, a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. In an example, the low friction material includes a polyketone, a polyaramid, a polyimide, a polyetherimide, a polyamideimide, a polyphenylene sulfide, a polyphenylene sulfone, a fluoropolymer, a polybenzimidazole, a derivative thereof, or a combination thereof. In a particular example, the low friction material may include a polymer, such as a polyketone, a thermoplastic polyimide, a polyetherimide, a polyphenylene sulfide, a polyether sulfone, a polysulfone, a polyamideimide, a derivative thereof, or a combination thereof. In a further example, the low friction material may include polyketone, such as polyether ether ketone (PEEK), polyether ketone, polyether ketone ketone, polyether ketone ether ketone, a derivative thereof, or a combination thereof. In an additional example, the low friction material may include an ultra high molecular weight polyethylene. In an additional example, the low friction material may include a fluoropolymer. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof. The low friction material may include a solid based material including lithium soap, graphite, boron nitride, molybdenum disulfide, tungsten disulfide, polytetrafluoroethylene, carbon nitride, tungsten carbide, or diamond like carbon, a metal (such as aluminum, zinc, copper, magnesium, tin, platinum, titanium, tungsten, lead, iron, bronze, steel, spring steel, stainless steel), a metal alloy (including the metals listed), an anodized metal (including the metals listed) or any combination thereof.

As used herein, a “low friction material” can be a material having a dry static coefficient of friction as measured against steel of less than 0.5, such as less than 0.4, less than or even less than 0.2. A “high friction material” can be a material having a dry static coefficient of friction as measured against steel of greater than 0.6, such as greater than 0.7, greater than 0.8, greater than 0.9, or even greater than 1.0.

In a number of embodiments, the low friction material may further include fillers, including glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), LCP, aromatic polyesters, molybdenum disulfide, tungsten disulfide, graphite, grapheme, expanded graphite, boron nitride, talc, calcium fluoride, barium sulfate, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof. Fillers can be in the form of beads, fibers, powder, mesh, or any combination thereof.

In an embodiment, the low friction layer 1104 can have an axial thickness T_{FL} in a range of 0.01 mm and 0.4 mm, such as in a range of 0.15 mm and 0.35 mm, or even in a range of mm and 0.3 mm. The axial thickness of the low friction 1104 may be uniform, i.e., an axial thickness at a first location of the low friction layer 1104 can be equal to an axial thickness at a second location therealong. The low friction layer 1104 may overlie one major surface of the substrate 1119, shown, or overlie both major surfaces. In a number of embodiments, the substrate 1119 may extend at least partially along a length of the composite material 1000. The substrate 1119 may be at least partially encapsulated by the low friction layer 1104. That is, the low friction layer 1104 may cover at least a portion of the substrate 1119. Axial surfaces of the substrate 1119 may or may not be exposed from the low friction 1104. In an embodiment, the composite material 1000 can have an axial thickness T_{SW} in a range of 0.01 mm and 5 mm, such as in a range of 0.15 mm and 2.5 mm, or even in a range of 0.2 mm and 1 mm.

FIG. 2C includes an illustration of an alternative embodiment of the composite material that may be formed according to first step 12 and second step 14 of the forming process 10. For purposes of illustration, FIG. 2C shows the layer by layer configuration of a composite material 1002 after second step 14. According to this particular embodiment, the composite material 1002 may be similar to the composite material 1001 of FIG. 2B, except this composite material 1002 may also include at least one adhesive layer 1121 that may couple the low friction layer 1104 to the substrate 1119 (i.e., the base material provided in the first step 12) and a low friction layer 1104 (i.e., the low friction coating applied in second step 14). In another alternate embodiment, the substrate 1119, as a solid component, woven mesh or expanded metal grid, may be embedded between at least one adhesive layer 1121 included between the low friction layer 1104 and the substrate 1119.

The adhesive layer 1121 may include any known adhesive material common to the fastener arts including, but not limited to, fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof. Additionally, the adhesive can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive can include a copolymer. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C. The adhesive layer 1121 can have an axial thickness of about 1 to 50 microns, such as about 7 to 15 microns.

FIG. 2D includes an illustration of an alternative embodiment of the composite material that may be formed according to first step 12 and second step 14 of the forming process For purposes of illustration, FIG. 2D shows the layer by layer configuration of a composite material 1002 after second step 14. According to this particular embodiment, the composite material 1002 may be similar to the composite material 1002 of FIG. 2C, except this composite material 1002 may also include at least one corrosion protection layer 1704, 1705, and 1708, and a corrosion resistant coating 1125 that can include an adhesion promoter layer 1127 and an epoxy layer 1129 that may couple to the substrate 1119 (i.e., the base material provided in the first step 12) and a low friction layer 1104 (i.e., the low friction coating applied in second step 14).

The substrate 1119 may be coated with corrosion protection layers 1704 and 1705 to prevent corrosion of the composite material 1002 prior to processing. Additionally, a corrosion protection layer 1708 can be applied over layer 1704. Each of layers 1704, 1705, and 1708 can have an axial thickness of about 1 to 50 microns, such as about 7 to 15 microns. Layers 1704 and 1705 can include a phosphate of zinc, iron, manganese, or any combination thereof, or a nano-ceramic layer. Further, layers 1704 and 1705 can include functional silanes, nano-scaled silane based primers, hydrolyzed silanes, organosilane adhesion promoters, solvent/water based silane primers, chlorinated polyolefins, passivated surfaces, commercially available zinc (mechanical/galvanic) or zinc-nickel coatings, or any combination thereof. Layer 1708 can include functional silanes, nano-scaled silane based primers, hydrolyzed silanes, organosilane adhesion promoters, solvent/water based silane primers. Corrosion protection layers 1704, 1706, and 1708 can be removed or retained during processing.

The composite material 1002 may further include a corrosion resistant coating 1125. The corrosion resistant coating 1125 can have a axial thickness of about 1 to 50 microns, such as about 5 to 20 microns, and such as about 7 to 15 microns. The corrosion resistant coating 1125 can include an adhesion promoter layer 1127 and an epoxy layer 1129. The adhesion promoter layer 1127 can include a phosphate of zinc, iron, manganese, tin, or any combination thereof, or a nano-ceramic layer. The adhesion promoter layer 1127 can include functional silanes, nano-scaled silane based layers, hydrolyzed silanes, organosilane adhesion promoters, solvent/water based silane primers, chlorinated polyolefins, passivated surfaces, commercially available zinc (mechanical/galvanic) or Zinc-Nickel coatings, or any combination thereof. The epoxy layer 1129 can be a thermal cured epoxy, a UV cured epoxy, an IR cured epoxy, an electron beam cured epoxy, a radiation cured epoxy, or an air cured epoxy. Further, the epoxy layer 1129 can include polyglycidylether, diglycidylether, bisphenol A, bisphenol F, oxirane, oxacyclopropane, ethylenoxide, 1,2-epoxypropane, 2-methyloxirane, 9,10-epoxy-9,10-dihydroanthracene, or any combination thereof. The epoxy layer 1129 can further include a hardening agent. The hardening agent can include amines, acid anhydrides, phenol novolac hardeners such as phenol novolac poly[N-(4-hydroxyphenyl)maleimide] (PHPMI), resole phenol formaldehydes, fatty amine compounds, polycarbonic anhydrides, polyacrylate, isocyanates, encapsulated polyisocyanates, boron trifluoride amine complexes, chromic-based hardeners, polyamides, or any combination thereof. Generally, acid anhydrides can conform to the formula R—C═O—O—C═O—R′ where R can be C_{X}H_{Y}X_{Z}A_{U} as described above. Amines can include aliphatic amines such as monoethylamine, diethylenetriamine, triethylenetetraamine, and the like, alicyclic amines, aromatic amines such as cyclic aliphatic amines, cyclo aliphatic amines, amidoamines, polyamides, dicyandiamides, imidazole derivatives, and the like, or any combination thereof.

In an embodiment, under step 14 of FIG. 1, any of the layers on the composite material 1001, 1002, 1002, as described above, can each be disposed in a roll and peeled therefrom to join together under pressure, at elevated temperatures (hot or cold pressed or rolled), by an adhesive, or by any combination thereof. Any of the layers of the composite material 1000, as described above, may be laminated together such that they at least partially overlap one another. Any of the layers on the composite material 1001, 1002, 1002, as described above, may be applied together using coating techniques, such as, for example, physical or vapor deposition, spraying, plating, powder coating, or through other chemical or electrochemical techniques. In a particular embodiment, the low friction layer 1104 may be applied by a roll-to-roll coating process, including for example, extrusion coating. The low friction layer 1104 may be heated to a molten or semi-molten state and extruded through a slot die onto a major surface of the substrate 1119. In another embodiment, the low friction layer 1104 may be cast or molded.

In other embodiments, under step 14 of FIG. 1, any of the layers on the composite material 1001, 1002, 1002, as described above, may be applied by a coating technique, such as, for example, physical or vapor deposition, spraying, plating, powder coating, or through other chemical or electrochemical techniques. In a particular embodiment, the low friction layer 1104 may be applied by a roll-to-roll coating process, including for example, extrusion coating. The low friction layer 1104 may be heated to a molten or semi-molten state and extruded through a slot die onto a major surface of the substrate 1119. In another embodiment, the low friction layer 1104 may be cast or molded.

As a result of the method of FIG. 1, according to embodiments described above, the low friction material, which covers the substrate 1119 as a low friction layer 1104, or forms the substrate 1119, may be textured to have microscopically minute asperities (e.g. apexes and nadirs on a surface), which forms the low friction surface, instead of variation in macroscopic thickness of the low friction material itself.

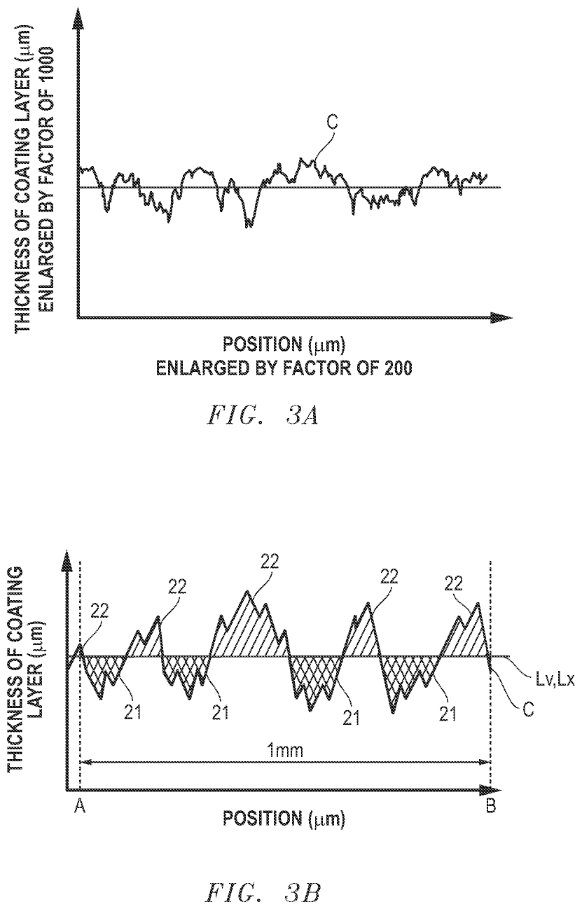

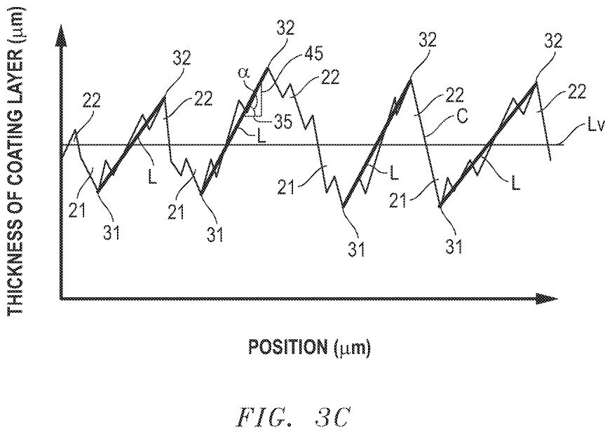

FIG. 3A is an enlarged view with the X-axis enlarged by a factor of 200 and the Y-axis enlarged by a factor of 1000. The surface shape of the low friction material is acquired as a shape line C shown in FIG. 3A. The shape line C represents the apexes and nadirs of the surface of the low friction material in a cross section containing a plane parallel to the thickness direction of the low friction layer 1104. The shape line C is expressed by using an X-Y coordinate system. Specifically, the X-axis represents a position between two arbitrary points, and the Y-axis represents the thickness direction of the low friction material, that is, the position in the Y-axis direction represents the depth and height of the apexes and nadirs of the surface. The shape line C therefore contains apexes and nadirs according to the surface shape of the low friction layer 1104.

FIG. 3B diagrammatically shows a simplified version of the shape line C shown in FIG. 3A for the sake of illustration. The shape line C containing apexes and nadirs is divided by an imaginary straight line Lx, which is parallel to the X axis as a reference, into upper and lower parts in the Y-axis direction. In a case where the low friction surface of the low friction material is microscopically flat, the low friction surface of the low friction material, the X-axis, and the imaginary straight line Lx are parallel to one another. When the shape line C is divided by the imaginary straight line Lx, recessed regions (nadirs) that protrude downward from the imaginary straight line Lx and protruding regions (apexes) that protrude upward from the imaginary straight line Lx are separated from each other. In FIG. 3B, the recessed regions are “meshed,” and the protruding regions are “hatched.” The imaginary straight line Lx, which is so positioned that the sum S1 of the areas of the recessed regions is equal to the sum S2 of the areas of the extended regions, is defined as an extension and recess average line Lv. That is, across the low friction surface of the low friction material, the sum S1 of the areas of the recessed regions that protrude downward from the extension and recess average line Lv is equal to the sum S2 of the areas of the protruding regions that protrude upward from the extension and recess average line Lv (S1=S2). The regions that protrude downward from the extension and recess average line Lv are defined as nadirs 21, and the regions that protrude upward from the extension and recess average line Lv are defined as apexes 22.

In the present embodiment, the X-axis is defined in the center position in the circumferential direction and the radial direction of the surface of the low friction material and defined as the direction tangential to the circumferential direction for measurement. The arbitrary two points can be arbitrarily adjusted in terms of the number of locations, the positions, and the direction in the measurement in consideration of the disposition of the low friction material.

FIG. 3C diagrammatically shows a simplified version of the shape line C shown in FIG. 3B for the sake of illustration. In the present embodiment, the performance of the low friction material is further verified by using the relationship between a nadir 21 and an apex 22 adjacent to each other. Each of the nadirs 21 has a bottom 31 in the deepest position of the nadir 21, that is, in the position closest to the center of the base material. The extension 22 adjacent to the nadir 21 has an apex 32 in the highest position of the apex 22, that is, in the position farthest from the center of the base material. As described above, when a nadir 21 and an apex 22 are adjacent to each other with the extension and recess average line Lv therebetween, the bottom 31 of the nadir 21 and the apex 32 of the apex 22 can be connected to each other with an imaginary straight line L. The gradient of the straight line L is the value calculated by dividing a measured distance between the bottom 31 of the nadir 21 and the apex 32 of the apex 22 in the Y-axis direction, 45, by a measured distance between the bottom 31 and the apex 32 in the X-axis direction, 35. The average of the gradients of the resultant straight lines L is an average gradient SDQ or the root mean square gradient. In a number of embodiments, the root mean square gradient of the low friction material may be less than 0.064. Low friction materials having a root mean square gradient of the low friction material of less than 0.064 may be defined herein as being “high performance friction materials.”

Further, the root mean square gradient may have an average angle α from the nadir to the apex. The angle α may be at least 0.01°, such as 0.05°, such as 0.1°, such as 0.15°, such as 0.5°, such as 1°, such as 1.5°, such as 2°, or such as 3°.

Further, the apex material portion, Smr1, may be calculated as the percentage of the low friction material that includes the apexes. In other words, the thickness of the substrate may be termed T_{S}, and Smr1 is the area material ratio that divides the reduced apexes of the total thickness of the low friction material, T_{SL}, from the thickness of the substrate or core surface T_{S}. The reduced apexes are the areas that are removed by initial abrasion with a neighboring component. In a number of embodiments, the apex material portion, Smr1, of the low friction material may be less than 10%.

Further, the nadir material portion, Smr2, may be calculated as the percentage of the low friction material that includes the nadirs. In other words, the thickness of the substrate may be termed T_{S}, and Smr2 is the area material ratio that divides the reduced nadirs of the total thickness of the low friction material from the thickness of the substrate or core surface. The reduced nadirs are the areas that hold liquid (e.g. grease, lubricant) applied on the surface in order to improve lubricity. In a number of embodiments, the nadir material portion, Smr1, of the low friction material may be less than 75%. The resulting textured low friction layer 1104 may have a minimum distance between at least one apex 22 of the plurality of apexes 22 and at least one nadir 21 of the plurality of nadirs 21 may be 0.05 mm.

Referring now to the third step 16 of the forming process 10 as shown in FIG. 1, according to certain embodiments, forming the base material or composite material 1000, 1001, 1002, 1002 into a friction pad may include a cutting operation. In an embodiment, the cutting operation may include use of a stamp, press, punch, saw, or may be machined in a different way. In a number of embodiments, the cutting operation may form a peripheral surface on the friction pad. The cutting operation may define a cutting direction initiated from a first major surface to a second major surface, opposite the first major surface, to form the peripheral surfaces or edges. Alternatively, the cutting operation may define a cutting direction initiated from the second major surface to the first major surface to form the peripheral surfaces or edges.

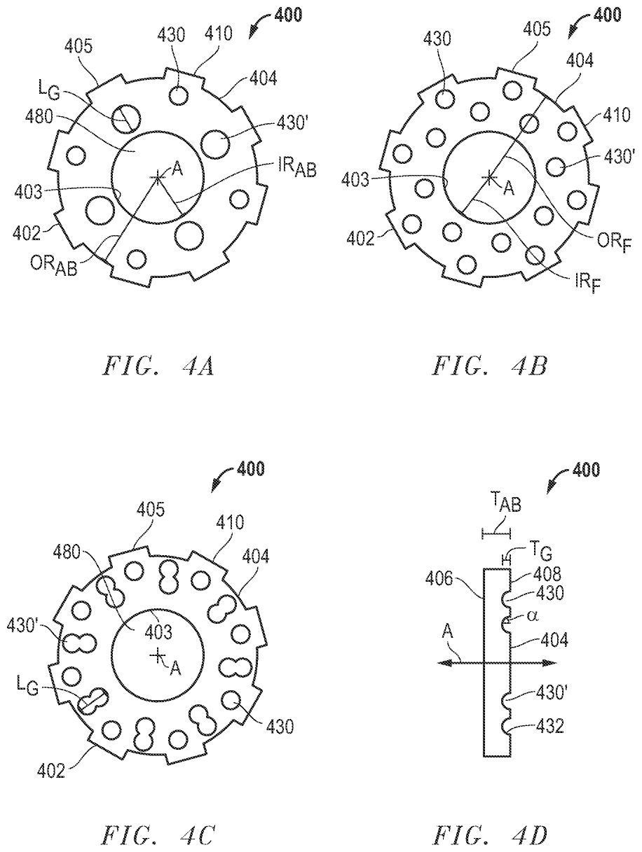

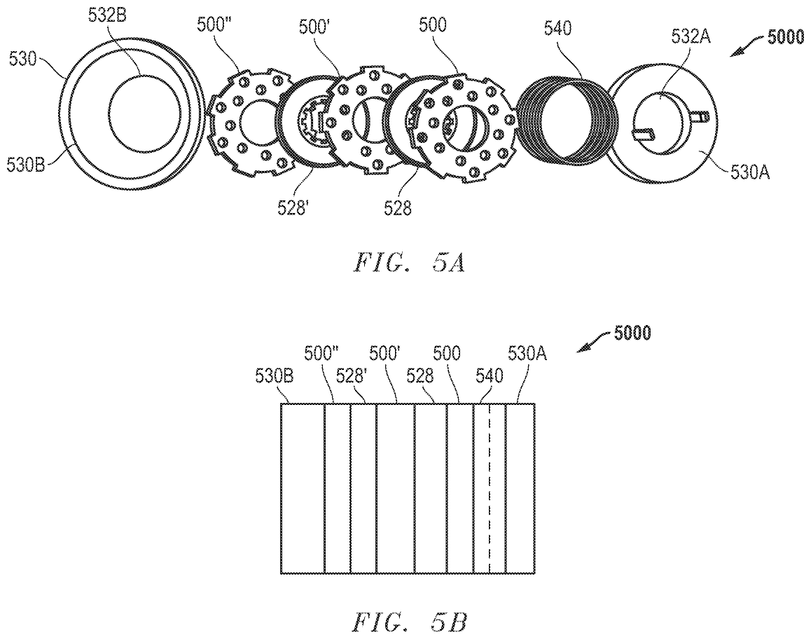

Turning now to the friction pad formed according to embodiments described herein, FIGS. 4A-4C includes a top view illustration of a friction pad 400. For purposes of illustration, FIGS. 4A-4C shows a top view of a friction pad 400 in accordance with embodiments described herein, which can include a friction pad body 402 oriented about a central axis A. The friction pad 400 and/or friction pad body 402 may further have an annular base 404. The annular base 404 may include an inner radial edge 403 and an outer radial edge 405. The inner radial edge 403 may at least partially define an aperture 480 in the friction pad 400. The aperture 480 may have a polygonal, oval, circular, semi-circular, or substantially circular cross-section when viewed in a plane generally perpendicular to the central axis A. The aperture 480 may be non-uniform in shape. The friction pad 400 and/or friction pad body 402 may further include at least one radial tab 410 disposed along at least one of the inner radial edge 403 or outer radial edge 405 of the annular base 404. In a number of embodiments, the radial tab 410 may run the entire circumference of the friction pad 400. According to still other embodiments, the friction pad 400 and/or friction pad body 402 may include a plurality of radial tabs 110, each extending from the annular base 404. According to some embodiments, the at least one radial tab 410 may project radially outwardly from the annular base 404. According to yet other embodiments, the at least one radial tab 410 may project radially inwardly from the annular base 404.

In a number of embodiments, as shown in FIG. 4A, the annular base 404 may have a particular outer radius OR_{AB}. For purposes of embodiments described herein and as shown in FIG. 4, the outer radius OR_{AB} of the annular base 404 is the distance from the central axis A to the outer radial edge 405. According to certain embodiments, the outer radius OR_{AB} of the annular base 404 may be at least 0.25 mm, at least 0.5 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 25 mm, at least 50 mm, at least 75 mm, at least 100 mm, at least 150 mm, at least 200 mm, at least 250 mm, at least 300 mm, at least 500 mm, at least 1000 mm, at least 5000 mm, or at least 10000 mm. According to still other embodiments, the outer radius OR_{AB} of the annular base 404 may be not greater than about 50000 mm, such as, not greater than about 10000 mm or even not greater than about 5000 mm. It will be appreciated that the outer radius OR_{AB} of the annular base 404 may be within a range between any of the minimum and maximum values noted above. It will be further appreciated that the outer radius OR_{AB} of the annular base 404 may be any value between any of the minimum and maximum values noted above. For example, the outer radius OR_{AB} of the annular base 404 may be 250 mm.

In a number of embodiments, as shown in FIG. 4A, the annular base 404 may have a particular inner radius IR_{AB}. For purposes of embodiments described herein and as shown in FIG. 4, the inner radius, IR_{AB} of the annular base 404 is the distance from the central axis A to the inner radial edge 403. According to certain embodiments, the inner radius IR_{AB} of the annular base 404 may be at least about 0.25 mm, at least 0.5 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 25 mm, at least 50 mm, at least 75 mm, at least 100 mm, at least 150 mm, at least 200 mm, at least 250 mm, at least 300 mm, at least 500 mm, at least 1000 mm, at least 5000 mm, or at least 10000 mm. According to still other embodiments, the inner radius IR_{AB} of the annular base 404 may be not greater than about 50000 mm, such as, not greater than about 10000 mm or even not greater than about 5000 mm. It will be appreciated that the inner radius IR_{AB} of the annular base 404 may be within a range between any of the minimum and maximum values noted above. It will be further appreciated that the inner radius IR_{AB} of the annular base 404 may be any value between any of the minimum and maximum values noted above. For example, the inner radius IR_{AB} of the annular base 404 may be 200 mm.

In a number of embodiments, as shown in FIG. 4B, the friction pad 400 may have an overall outer radius OR_{F}. For purposes of embodiments described herein, the outer radius OR_{F} of the friction pad 400 is the distance from the central axis A to the outer radial edge 405. According to certain embodiments, the outer radius OR_{F} of the friction pad 400 may be at least about 0.25 mm, at least 0.5 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 25 mm, at least 50 mm, at least 75 mm, at least 100 mm, at least 150 mm, at least 200 mm, at least 250 mm, at least 300 mm, at least 500 mm, at least 1000 mm, at least 5000 mm, or at least 10000 mm. According to still other embodiments, the outer radius OR_{F} of the friction pad 400 may be not greater than about 50000 mm, such as, not greater than about 10000 mm or even not greater than about 5000 mm. It will be appreciated that the outer radius OR_{F} of the friction pad 400 may be within a range between any of the minimum and maximum values noted above. It will be further appreciated that the outer radius OR_{F} of the friction pad 400 may be any value between any of the minimum and maximum values noted above. For example, the outer radius OR_{F} of the friction pad 400 may be 250 mm.

In a number of embodiments, as shown in FIG. 4B, the friction pad 400 may have an overall inner radius IR_{F}. For purposes of embodiments described herein, the inner radius IR_{F} of the friction pad 400 is the distance from the central axis A to the inner radial edge 403. According to certain embodiments, the inner radius IR_{F} of the friction pad 400 may be at least about 1 mm, such as, at least about 0.25 mm, at least 0.5 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 25 mm, at least 50 mm, at least 75 mm, at least 100 mm, at least 150 mm, at least 200 mm, at least 250 mm, at least 300 mm, at least 500 mm, at least 1000 mm, at least 5000 mm, or at least 10000 mm. According to still other embodiments, the inner radius IR_{F} of the friction pad 400 may be not greater than about 50000 mm, such as, not greater than about 10000 mm or even not greater than about 5000 mm. It will be appreciated that the inner radius IR_{F} of the friction pad 400 may be within a range between any of the minimum and maximum values noted above. It will be further appreciated that the inner radius IR_{F} of the friction pad 400 may be any value between any of the minimum and maximum values noted above. For example, the inner radius IR_{F} of the friction pad 400 may be 200 mm.

For purposes of illustration, FIG. 4D includes a cross-sectional view of a friction pad 400, as shown in FIG. 4A, in accordance with embodiments described herein. As shown in FIG. 4D, the annular base 404 can include a first axial surface 406 and a second axial surface 408 opposite the first axial surface 406 oriented down the central axis A and spaced apart by a axial thickness T_{AB}. The first axial surface 406 may define a first major surface while the second axial surface 408 may define a second major surface opposing the first major surface. The annular base 404 may have a polygonal, oval, circular, semi-circular, or substantially circular cross-section when viewed in a plane perpendicular to the central axis A.

In a number of embodiments, the annular base 404 may have a particular axial thickness T_{AB}. For purposes of embodiments described herein and as shown in FIG. 4D, the axial thickness T_{AB} of the annular base 404 is the distance from the first axial surface 406 to the second axial surface 408. According to certain embodiments, the axial thickness T_{AB} of the annular base 404 may be at least about 0.01 mm, such as, at least about 0.1 mm or at least about 0.2 mm or at least about 0.3 mm or at least about 0.4 mm or even at least about 0.5 mm. According to still other embodiments, the axial thickness T_{AB} of the annular base 404 may be not greater than about 2 mm, such as, not greater than about 0.9 mm or even not greater than about 0.8 mm. It will be appreciated that the axial thickness T_{AB} of the annular base 404 may be within a range between any of the minimum and maximum values noted above. It will be further appreciated that the axial thickness T_{AB} of the annular base 404 may be any value between any of the minimum and maximum values noted above. For example, the axial thickness T_{AB} of the annular base 404 may be 0.7 mm.

In a number of embodiments, as shown in FIG. 4D, the friction pad 400 can have an axial thickness T_{F}. For purposes of embodiments described herein, the axial thickness T_{F} of the friction pad 400 is the distance from the first axial surface 406 to the second axial surface 408. According to certain embodiments, the axial thickness T_{F} of the friction pad 400 may be at least about 0.1 mm, such as, at least about 0.2 mm or at least about 0.3 mm or at least about 0.4 mm or even at least about 0.5 mm. According to still other embodiments, the axial thickness T_{F} of the friction pad 400 may be not greater than about 100 mm, such as, not greater than about 90 mm or even not greater than about 80 mm. It will be appreciated that the axial thickness T_{F} of the friction pad 400 may be within a range between any of the minimum and maximum values noted above. It will be further appreciated that the axial thickness T_{F} of the friction pad 400 may be any value between any of the minimum and maximum values noted above. For example, the axial the axial thickness T_{F} of the friction pad 400 may be 0.7 mm.

Referring to FIGS. 4A-4D, in a number of embodiments, the friction pad 400 and/or friction pad body 402 may include at least one groove 430 on at least one major surface 406, 408. The at least one groove 430 may include a plurality of grooves 430, 430′. The at least one groove 430 may be adapted to retain a lubricant within an assembly as described below. In a number of embodiments, at least one of the plurality of grooves 430 may be disposed on an inner radius of at least one of the major surfaces 406, 408 of the friction pad 400 and/or friction pad body 402. In a number of embodiments, at least one of the plurality of grooves 430 may be disposed on an outer radius of at least one of the major surfaces 406, 408 of the friction pad 400 and/or friction pad body 402. The plurality of grooves 430, 430′ can be circumferentially offset from one another about the circumference of the friction pad 400 and/or friction pad body 402. The at least one groove 430 may include a gap, a slot, a channel, or a trough. In a number of embodiments, the at least one groove 430 may have a rectilinear or arcuate cross-sectional shape when viewed in a plane generally perpendicular to the central axis A. In a number of embodiments, as shown in FIGS. 4A-4C, the at least one groove 430 may have a polygonal, oval, circular, semi-circular, or substantially circular cross-sectional shape when viewed in a plane generally perpendicular to the central axis A. In a number of embodiments, as shown best in FIG. 4C, the at least one groove 430 may have a figure eight cross-sectional shape when viewed in a plane generally perpendicular to the central axis A. In a number of embodiments, as shown best in FIGS. 4A-4C, the plurality of grooves may include a first groove shape 430 and a second groove shape 430′, where the first groove shape 430 and the second groove shape 430′ may be patterned alternatively around the circumference of at least one of the major surfaces 406, 408 of the friction pad 400 and/or friction pad body 402. In a number of embodiments, the plurality of grooves may include a first groove shape 430 and a second groove shape 430′, where at least two of the first groove shape 430 or the second groove shape 430′ may be patterned consecutively around the circumference of at least one of me the major surfaces 406, 408 of the friction pad 400 and/or friction pad body 402.

In a number of embodiments, the total combined area of the plurality of grooves 430, 430′ may account for at least 10% of the surface area of at least one of the major surfaces 406, 408 of the friction pad 400 and/or friction pad body 402, such as at least 15%, such as at least 20%, such as at least 25%, such as at least 30%, such as at least 35%, such as at least 40%, such as at least 45%, such as at least 50%, such as at least 55%, or such as at least 60% of the surface area of at least one of the major surfaces 406, 408 of the friction pad 400 and/or friction pad body 402. It will be appreciated that the total combined area of the plurality of grooves 430, 430′ may be within a range between any of the values noted above. It will be further appreciated that the total combined area of the plurality of grooves 430, 430′ may be any value between any of the values noted above.

Referring back to FIG. 4A, in a number of embodiments, at least one of the plurality of grooves has a major length, L_{G}, defined as the longest radial length of the groove. For purposes of embodiments described herein and as shown in FIG. 4A, the major length L_{G}of at least one of the plurality of grooves 430 may be at least about 0.01 mm, such as, at least about 0.5 mm or at least about 1 mm or at least about 5 mm or at least about 10 mm or even at least about 25 mm. According to still other embodiments, the major length L_{G} of at least one of the plurality of grooves 430 may be not greater than about 200 mm, such as, not greater than about 100 mm or even not greater than about 50 mm. It will be appreciated that the major length L_{G} of at least one of the plurality of grooves 430 may be within a range between any of the minimum and maximum values noted above. It will be further appreciated that the major length L_{G} of at least one of the plurality of grooves 430 may be any value between any of the minimum and maximum values noted above. For example, the major length L_{G} of at least one of the plurality of grooves 430 may be 30 mm. In a number of embodiments, the major length, L_{G}, may be related to the outer radius of the friction pad, OR_{F}, where L_{G}≥0.1 OR_{F}, such as L_{G}≥0.25 OR_{F}, such as L_{G}≥0.3 OR_{F}, or such as L_{G}≥0.35 OR_{F}.

In a number of embodiments, at least one of the plurality of grooves 430 may have a particular groove depth T_{G}. For purposes of embodiments described herein and as shown in FIG. 4D, the groove depth T_{G} of at least one of the plurality of grooves 430 may be at least about 0.01 mm, such as, at least about 0.1 mm or at least about 0.2 mm or at least about 0.3 mm or at least about 0.4 mm or even at least about 0.5 mm. According to still other embodiments, the groove depth T_{G} of at least one of the plurality of grooves 430 may be not greater than about 2 mm, such as, not greater than about 0.9 mm or even not greater than about 0.8 mm. It will be appreciated that the groove depth T_{G} of at least one of the plurality of grooves 430 may be within a range between any of the minimum and maximum values noted above. It will be further appreciated that the groove depth T_{G} of at least one of the plurality of grooves 430 may be any value between any of the minimum and maximum values noted above. For example, the groove depth T_{G} of at least one of the plurality of grooves 430 may be 0.2 mm.

In a number of embodiments, at least one of the plurality of grooves 430 may have a groove sidewall 432 that may be disposed parallel with the central axis A of the friction pad 400 and/or friction pad body 402. In a number of embodiments, at least one of the plurality of grooves 430 may have a groove sidewall 432 that may be disposed at an angle, a with the central axis A of the friction pad 400 and/or friction pad body 402. In a number of embodiments, the angle, α, may be at least 0.05 degrees, at least 0.10 degrees, at least 0.15 degrees, at least 0.25 degrees, at least 0.5 degrees, at least 1 degree, at least 2 degrees, at least 3 degrees, at least 4 degrees, at least 5 degrees, or at least 10 degrees. In a number of embodiments, the angle, α, may be not greater than 30 degrees, not greater than 20 degrees, not greater than 15 degrees, not greater than 10 degrees, not greater than 5 degrees, not greater than 4 degrees, not greater than 3 degrees, not greater than 2 degrees, not greater than 1 degree, not greater than 0.5 degrees, or not greater than 0.25 degrees. It will be appreciated that the angle, α, may be within a range between any of the minimum and maximum values noted above. It will be further appreciated that the angle, α, may be any value between any of the minimum and maximum values noted above. For example, the angle, α, may be 20 degrees.

For purposes of illustration, FIGS. 5A-5B includes a top view breakout view, and a cross-sectional view respectively of at least one friction pad 500 within an assembly 5000 in accordance with embodiments described herein. It will be appreciated that corresponding components between FIGS. 5A-5B (i.e., components having the corresponding reference number) may be described as having any of the characteristics or features described above. In a number of embodiments, the friction pad 500 can be disposed adjacent to, or contacting, at least one inner member 528 (such as a rotator or other structural member) in an assembly 5000. The assembly 5000 may also include an outer member 530 (such as a bearing, housing, a side member, or other structural member) disposed outside the inner member 528 and/or friction pad 500. In an embodiment, the outer member 530 may be adapted to rotate relative to the inner member 528. In another embodiment, the inner member 528 may be adapted to rotate relative to the outer member 530. The friction pad 500 can be disposed adjacent to, or contacting, an inner member 528 in an assembly 500. In a number of embodiments, the friction pad 500 may be installed on the inner member 528 in the assembly 500. In a number of embodiments, the at least one radial tab 510 of the friction pad 500 may fix the friction pad 400 to the inner member 528 in the assembly 5000. In a number of embodiments, the assembly 5000 may be a friction assembly including, but not limited to, a spindle drive.

In a number of embodiments, the assembly 5000 may include a plurality of friction pads 500, 500′, 500″. In a number of embodiments, the assembly 5000 may include at least two friction pads 500, 500′. In a number of embodiments, the assembly 5000 may include at least three friction pads 500, 500′, 500″. In a number of embodiments, the assembly 5000 may include a plurality of inner members 528, 528′. In a number of embodiments, the assembly 5000 may include at least two inner members 528, 528′. In a number of embodiments, the assembly 5000 may include at least three inner members 528, 528′.

In a number of embodiments, the assembly 5000 may include an outer member 530 including a housing. The housing 530 may include a cap 530A and a base 530B. The cap 530A and base 530B may enclose the at least one friction pad 5000 and at least one inner member 528 within the assembly 5000. Further, at least one of the cap 530A or base 530B may include an input/output connector 532. The input/output connector 532 may connect the cap 530A or base 530B to an additional component including, but not limited to, the torque supplying input or the torque receiving output. The torque supplying input or the torque receiving output may be a shaft, rotator or any other component known in the torque assembly arts. In an embodiment, the input/output connector 532 may include a male attachment. The male attachment may include a protrusion. The protrusion may have a non-round or polygonal cross-section. In another embodiment, the input/output connector 532 may include a female attachment. The female attachment may include a bore. The bore may have a non-round or polygonal cross-section. As shown in FIG. 5, the cap 530A and base 530B each include an input/output connector 532A, 532B including a female attachment.

In an embodiment, the assembly 5000 may further include a spring component 540. The spring component 540 may provide a compressive force against a neighboring component of the assembly 5000. The compression force may be at least 10 N against a neighboring component, such as at least 20 N, at least 30 N, at least 40 N, at least 50 N, at least 100 N, or even at least 150 N. In another embodiment, the compression force may be no greater than 1500 N, no greater than 1000 N, no greater than 750 N, or even no greater than 250 N against a neighboring component of the assembly 5000. It will be appreciated that compression force of the spring component 540 may be within a range between any of the minimum and maximum values noted above. It will be further appreciated that the compression force of the spring component 540 may be any value between any of the minimum and maximum values noted above. For example, the compression force of the spring component 540 may be 150 N.

In a number of embodiments, at least one of the inner member(s) 528, outer member(s) 530, or spring component(s) 540 can include any suitable material with sufficient rigidity to withstand axial and longitudinal forces. In a particular embodiment, at least one of the inner member(s) 528, outer member(s) 530, or spring component(s) 540 can include a polymer, such as, for example, ultra-high molecular weight polyurethane (UHMWPE), poly(vinyl chloride) (PVC), a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), aliphatic polyamides, or even para-aramids such as Kevlar®, or any combination thereof. The polymer may be injection-molded. In another embodiment, at least one of the inner member(s) 528, outer member(s) 530, or spring component(s) 540 can include a metal or alloy (such as, but not limited to, aluminum, chromium, nickel, zinc, copper, magnesium, tin, platinum, titanium, tungsten, lead, iron, bronze, steel, spring steel, stainless steel) formed through a machining process. In a number of embodiments, the metal may be lubricious. In yet another embodiment, at least one of the inner member(s) 528, outer member(s) 530, or spring component(s) 540 can include a ceramic or any other suitable material. At least one of the inner member(s) 528, outer member(s) 530, or spring component(s) 540 can include a homogenous composition or may include two or more discrete portions having different compositions. At least one of the inner member(s) 528, outer member(s) 530, or spring component(s) 540 can be formed from a single piece, two pieces, or several pieces joined together by melting, sintering, welding, adhesive, fasteners, threading, or any other suitable fastening means. Moreover, in one non-limiting embodiment, although not applicable to all embodiments, at least one of the inner member(s) 528, outer member(s) 530, or spring component(s) 540 may not include a polymer, and more particularly, may be essentially free of any/all polymers. In a particular aspect, at least one of the inner member(s) 528, outer member(s) 530, or spring component(s) 540 may include a single material free of any coating or surface layer. In a number of embodiments, at least one of the inner member(s) 528, outer member(s) 530, or spring component(s) 540 can include a coating on the surface of the at least one of the inner member(s) 528, outer member(s) 530, or spring component(s) 540. In a number of embodiments, the coating may include a lubricant. The lubricant may include a grease including at least one of lithium soap, lithium disulfide, graphite, mineral or vegetable oil, silicone grease, fluorether-based grease, apiezon, food-grade grease, petrochemical grease, or may be a different type. The lubricant may include an oil including at least one of a Group I-Group III+oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based, or may be a different type. Further, generally, the assembly 5000 can include a lubricant, including the lubricants listed above. In a certain aspect, at least one of the inner member(s) 528, outer member(s) 530, or spring component(s) 540 can be formed from a monolithic construction. In another aspect, at least one of the inner member(s) 528, outer member(s) 530, or spring component(s) 540 can be formed from multiple components joined together by any means recognizable in the art, such as, for example, by mechanical deformation (e.g., crimping or splines), adhesive, welding, melting, or any combination thereof.

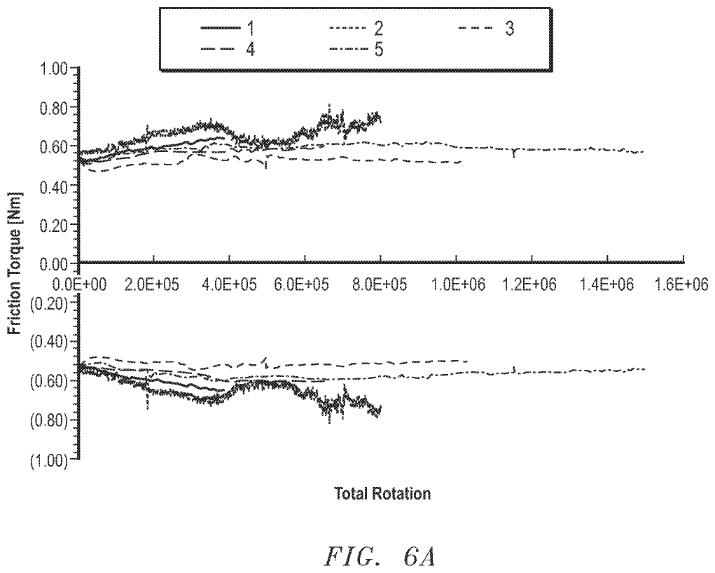

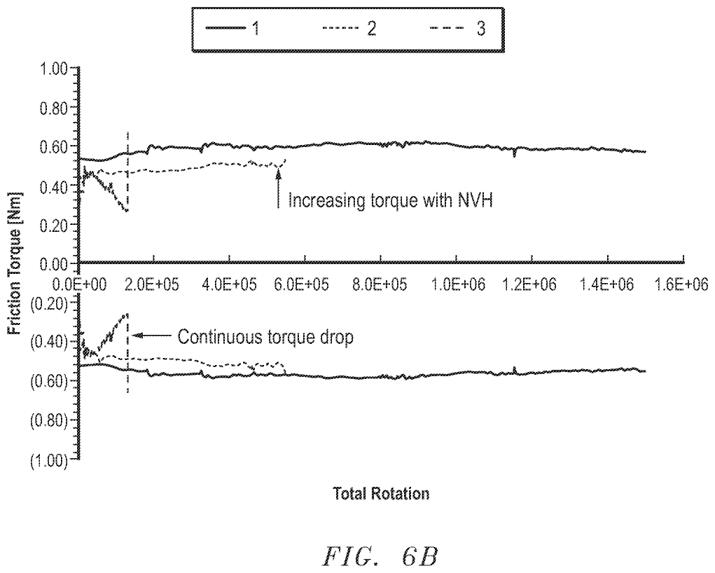

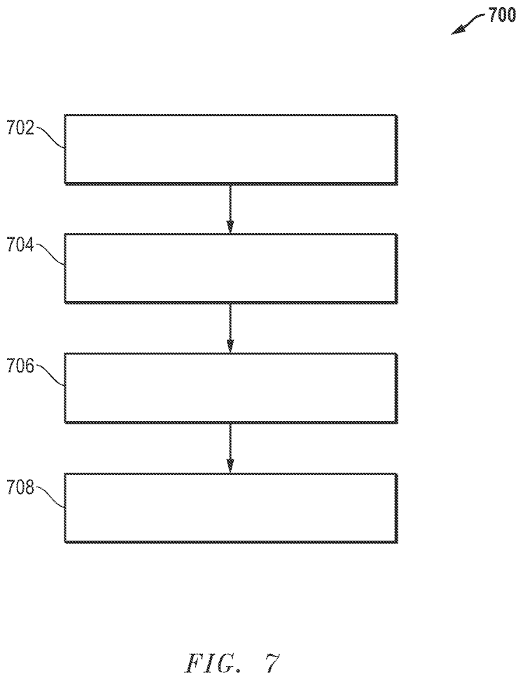

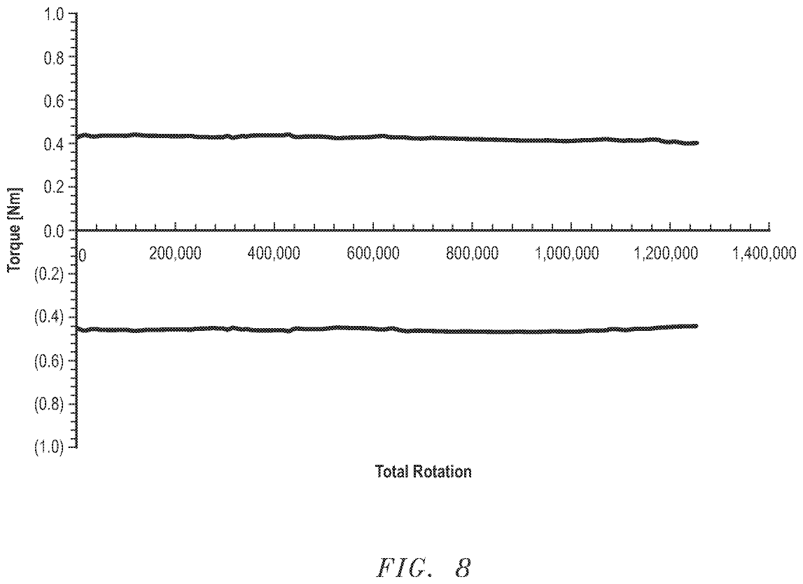

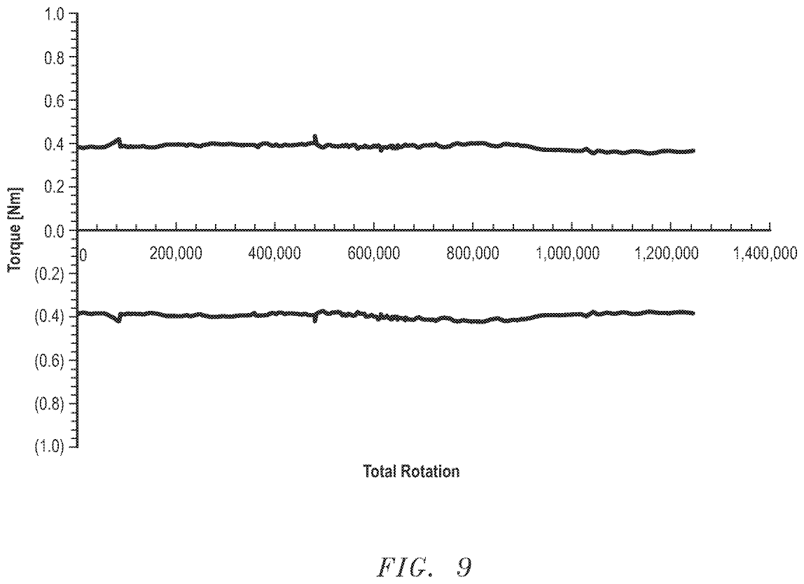

For purposes of illustration, FIGS. 6A-6B include graphs of frictional torque variation versus number of total rotations for friction pads within assemblies according to embodiments herein. As defined herein, a “test cycle” is a clockwise rotation for a certain time followed by a counter-clockwise rotation for a certain time with “rotation” meaning the sample has 360° of movement. Each “test cycle” has a speed (rpm)/60 times the movement time of (clockwise rotation and counter-clockwise rotation). Different test protocols (i.e. different total “test cycle,” different speed, different movement time”) were used to test the samples, however, while the samples were tested with different protocols, the same total rotations were used for each sample. Therefore, total rotations will be used as the testing parameter. In FIG. 6A, the test procedure was 200 rpm with 1 test cycle containing: clockwise rotation for 6 seconds, stop for 12 seconds, counter-clockwise rotation for 6 seconds, stop for 12 seconds with 30,000 total cycles. The same material was used in all friction pads tested. In FIG. 6A, Sample line 1 shows a friction assembly with 3 conventional friction pads without grooves and 2 steel rotators; sample line 2 shows a friction assembly with 3 friction pads of the embodiment shown in FIG. 4A and 2 steel rotators; sample line 3 shows a friction assembly with 3 friction pads of the embodiment shown in FIG. 4B and 2 steel rotators; sample line 4 shows a friction assembly with 2 friction pads of the embodiment shown in FIG. 4B and 1 steel rotator; and sample line 5 shows a friction assembly with 2 friction pads of the embodiment shown in FIG. 4C and 1 steel rotator. In FIGS. 6A-6B, the friction pads are always in a contact configuration where they only contact rotators. For example, the configuration of 3 friction pads and 2 steel rotators goes friction pad/rotator/friction pad/rotator/friction pad. As shown in FIG. 6A, the friction assembly shows minimal variation of frictional torque over a large test cycle time when using friction pads according to embodiments herein within a friction assembly. In FIG. 6B, the test procedure was 200 rpm with 1 cycle containing: clockwise rotation for 6 seconds, stop for 12 seconds, counter-clockwise rotation for 6 seconds, stop for 12 seconds with 30,000 total cycles. In FIG. 6B, Sample line 1 shows a friction assembly with 2 friction pads with a first high performance friction material of the embodiment shown in FIG. 4C and 1 steel rotator; sample line 2 shows a friction assembly with 3 friction pads with a second high performance friction material of the embodiment shown in FIG. 4C and 2 steel rotators; sample line 3 shows a friction assembly with 3 friction pads without a high performance friction material of the embodiment shown in FIG. 4B and 2 steel rotators. As shown in FIG. 6B, the friction assembly shows minimal variation of frictional torque over a large test cycle time when using friction pads according to embodiments herein within a friction assembly.

As stated above, the at least one groove on the friction pad may be adapted to retain a lubricant within an assembly. As the lubricant is retained within the at least one groove, the frictional performance provides less variation as shown in FIGS. 6A-6B due to ease of rotation of the rotators against the friction pads within the assembly. As shown the torque assembly according to embodiments herein may provide a frictional torque that varies by less than +/−20% from a baseline torque value over at least 1 million test cycles and over a temperature range of −40 C-80 C.

In an embodiment, the assembly 5000 can be installed or assembled by an assembly force of at least 10 N a longitudinal direction relative to the inner member 528, such as at least 20 N, at least 30 N, at least 40 N, at least 50 N, at least 100 N, or even at least 150 N. In a further embodiment, the assembly 5000 can be installed or assembled by an assembly force of at least 1 kgf in a longitudinal direction relative to the inner member 528, such as no greater than 1500 N, no greater than 1000 N, no greater than 750 N, or even no greater than 250 N.

FIG. 7 illustrates a method in accordance with an embodiment. The method 700 may include step 702 of providing a housing including a base and a cap. The method 700 may include step 704 of providing at least one rotator disposed within the housing. The method 700 may include step 706 of providing at least one friction pad disposed adjacent to a rotator, the friction pad including: a friction pad body including an annular base defining an aperture down a central axis, first and second opposing major surfaces, where the friction pad body includes a low friction material; The method 700 may include step 708 of rotating the at least one rotator to provide a torque assembly, where the torque assembly provides a frictional torque that varies by less than +/−20% from a baseline torque value over at least 1 million test cycles and over temperature range of −40 C to 80 C.

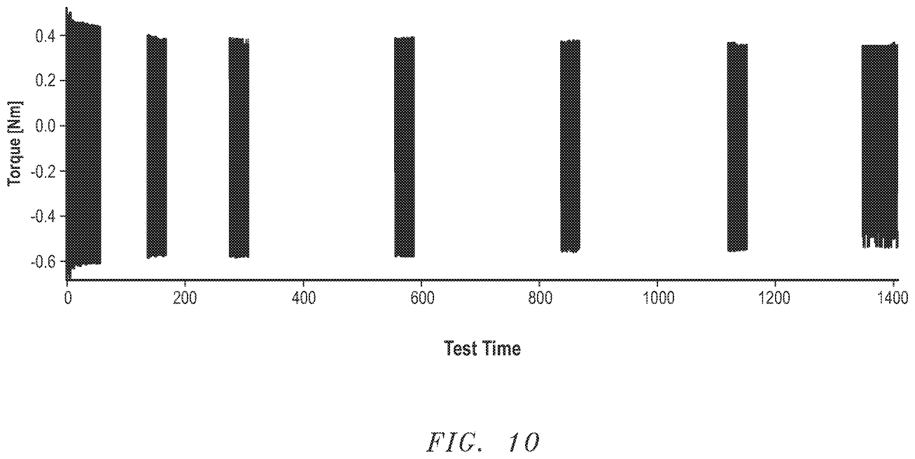

FIG. 8 includes a torque variation curve as a function of number of total rotations for a friction pad in an assembly in accordance with an embodiment. In FIG. 8, 3 friction pads according to the embodiment shown in FIG. 4C was tested for torque with 2 pieces of stainless steel inner members/rotators according to methods known in the art. In FIG. 8, the test procedure was 250 rpm with 1 test cycle containing: clockwise rotation for 3 seconds, stop for 5 seconds, counter-clockwise rotation for 3 seconds, stop for 5 seconds with 50,000 total cycles. As shown, the friction pad according to embodiments herein exhibits stable torque over an increasing number of test cycles, which is not achievable for friction pads known in the art.

FIG. 9 includes a torque variation curve as a function of number of total rotations for a friction pad in an assembly in accordance with an embodiment. In FIG. 9, 2 friction pads according to the embodiment shown in FIG. 4C was tested for torque with 1 piece of stainless steel inner member/rotator according to methods known in the art. In FIG. 9, the test procedure was 250 rpm with 1 test cycle containing: clockwise rotation for 3 seconds, stop for 5 seconds, counter-clockwise rotation for 3 seconds, stop for 5 seconds with 50,000 total cycles. As shown, the friction pad according to embodiments herein exhibits stable torque over an increasing number of test cycles, which is not achievable for friction pads known in the art.

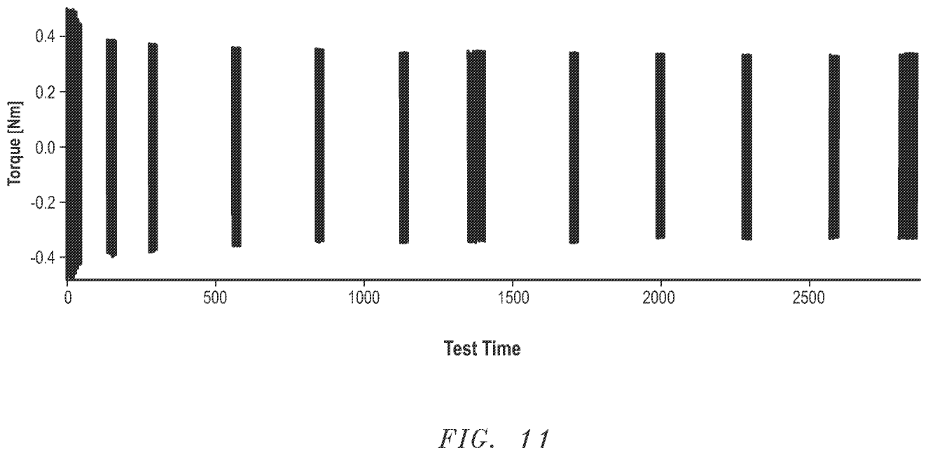

FIG. 10 includes a torque variation curve as a function of time for a friction pad in an assembly at a certain temperature in accordance with an embodiment. In FIG. 10, a friction pad according to the embodiment shown in FIG. 4C was tested for torque neighboring 1 piece of stainless steel inner member/rotator according to methods known in the art. Specifically, a single test cycle may be defined for FIG. 10 as having the rotators rotate at 250 rpm clockwise for 3 seconds, stop motion for 5 seconds, then rotate the rotators at 250 rpm counter-clockwise for 3 seconds, then stop for 5 seconds. This was done for 125,000 total rotations at a constant temperature of 25° C. As shown, the friction pad according to embodiments herein exhibits stable torque over an increasing number of test cycles, which is not achievable for friction pads known in the art.

FIG. 11 includes a torque variation curve as a function of time for a friction pad in an assembly at a certain temperature in accordance with an embodiment. In FIG. 11, a friction pad according to the embodiment shown in FIG. 4C was tested for torque neighboring 1 piece of stainless steel inner member/rotator according to methods known in the art. Specifically, a single test cycle may be defined for FIG. 11 as having the rotators rotate at 250 rpm clockwise for 3 seconds, stop motion for 5 seconds, then rotate the rotators at 250 rpm counter-clockwise for 3 seconds, then stop for 5 seconds. This was done for 250,000 total rotations at a constant temperature of 85° C. As shown, the friction pad according to embodiments herein exhibits stable torque over an increasing number of test cycles, which is not achievable for friction pads known in the art.

Use of the friction pad 400 or assembly 5000 may provide increased benefits in several applications such as, but not limited to, torque assemblies in vehicular suspensions, vehicular powertrains, friction brakes, spindle drives, or other types of applications. Notably, the use of the friction pad 400 may provide a simplification of the assembly 5000 by eliminating components. Further, use of the friction pad 400 may improve assembly forces required, compensate for axial tolerances between the inner and outer members 28, 30, and provide noise reduction and vibration decoupling within the assembly 5000. Further, the friction pad 400 may be a simple installation and be retrofit and cost effective across several possible assemblies of varying complexity. Further, the friction pad 400 may provide low friction properties and act as against a component of the assembly 5000. This can improve the friction performance between the friction pad 400 and other components of the assembly 5000 while providing constant frictional torque with little variation within the assembly across its lifetime. Lastly, the use of the friction pad 400 may maintain the improved stiffness and tensile strength, increasing the lifetime of the assembly 5000.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A friction pad comprising: a friction pad body comprising an annular base defining an aperture down a central axis, and first and second opposing major surfaces, wherein the friction pad body comprises a low friction material, and wherein at least one of the major surfaces comprises a plurality of grooves adapted to retain lubricant.

Embodiment 2: A torque assembly comprising: a housing comprising a base and a cap; at least one rotator disposed within the housing; and at least one friction pad disposed adjacent to a rotator, the friction pad comprising: a friction pad body comprising an annular base defining an aperture down a central axis, and first and second opposing major surfaces, wherein the friction pad body comprises a low friction material, wherein at least one of the major surfaces comprises a plurality of grooves adapted to retain lubricant.

Embodiment 3: A method comprising: providing a housing comprising a base and a cap; providing at least one rotator disposed within the housing; and providing at least one friction pad disposed adjacent to a rotator, the friction pad comprising: a friction pad body comprising an annular base defining an aperture down a central axis, and first and second opposing major surfaces, wherein the friction pad body comprises a low friction material; and rotating the at least one rotator to provide a torque assembly, wherein the torque assembly provides a frictional torque that varies by less than +/−20% from a baseline torque value over at least 1 million test cycles and over temperature range of −40 C to 80 C.

Embodiment 4: The friction pad, torque assembly, or method of any of embodiments 1-3, wherein the friction pad body comprises a plurality of radial tabs extending from the annular base, the radial tabs terminating radially inwardly or radially outwardly and providing a peripheral surface.

Embodiment 5: The torque assembly or method of embodiments 2-3, wherein the torque assembly further comprises a spring component.

Embodiment 6: The torque assembly or method of embodiment 5, wherein the spring component generates a compression force of 50 to 500 N.

Embodiment 7: The torque assembly or method of embodiments 2-3, wherein the torque assembly comprises at least two rotators.

Embodiment 8: The torque assembly or method of embodiments 2-3, wherein the torque assembly comprises at least two friction pads.

Embodiment 9: The torque assembly or method of embodiments 2-3, wherein the torque assembly comprises at least three friction pads.

Embodiment 10: The torque assembly of embodiment 2, wherein the torque assembly provides a frictional torque that varies by less than +/−20% from a baseline torque value over at least 1 million test cycles and over temperature range of −40 C to 80 C.

Embodiment 11: The torque assembly or method of embodiments 2-3, wherein the torque assembly includes a lubricant including at least one of lithium soap, lithium disulfide, graphite, mineral or vegetable oil, silicone grease, fluorether-based grease, apiezon, food-grade grease, petrochemical grease, Group I-GroupIII+oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based oil, PTFE thickened grease lithium soap, graphite, boron nitride, molybdenum disulfide, tungsten disulfide, polytetrafluoroethylene, a metal, or a metal alloy.

Embodiment 12: The friction pad, torque assembly, or method of any of embodiments 1-3, wherein at least one of the plurality of grooves is disposed on an inner radius of at least one of the major surfaces of the friction pad body.

Embodiment 13: The friction pad, torque assembly, or method of any of embodiments 1-3, wherein at least one of the plurality of grooves is disposed on an outer radius of at least one of the major surfaces of the friction pad body.

Embodiment 14: The friction pad, torque assembly, or method of any of embodiments 1-3, wherein at least one of the plurality of grooves has a pocket depth of at least 0.05 mm.

Embodiment 15: The friction pad, torque assembly, or method of any of embodiments 1-3, wherein at least one of the plurality of grooves has a major length, L_{G}, wherein the friction pad has an outer radius, OR_{F}, and wherein L_{G}≥0.1 OR_{F}, such as L_{G}≥0.25 OR_{F}, such as L_{G}≥0.3 OR_{F}, or such as L_{G}≥0.35 OR_{F}.

Embodiment 16: The friction pad, torque assembly, or method of any of embodiments 1-3, wherein the plurality of grooves account for at least 10% of the surface area of at least one of the major surfaces of the friction pad body.

Embodiment 17: The friction pad, torque assembly, or method of any of embodiments 1-3, wherein at least one of the plurality of grooves has a groove sidewall that is disposed parallel with the central axis of the friction pad.

Embodiment 18: The friction pad, torque assembly, or method of any of embodiments 1-3, wherein at least one of the plurality of grooves has a groove sidewall that is disposed at an angle, α, with the central axis of the friction pad.

Embodiment 19: The friction pad, torque assembly, or method of embodiment 18, wherein the angle, α, is at least 0.05 degrees, at least 0.10 degrees, at least 0.15 degrees, at least degrees, at least 0.5 degrees, at least 1 degree, at least 2 degrees, at least 3 degrees, at least 4 degrees, at least 5 degrees, or at least 10 degrees.

Embodiment 20: The friction pad, torque assembly, or method of embodiment 18, wherein the angle, α, is not greater than 30 degrees, not greater than 20 degrees, not greater than degrees, not greater than 10 degrees, not greater than 5 degrees, not greater than 4 degrees, not greater than 3 degrees, not greater than 2 degrees, not greater than 1 degree, not greater than degrees, or not greater than 0.25 degrees.

Embodiment 21: The friction pad, torque assembly, or method of any of embodiments 1-3, wherein the outer radius OR_{F} of the friction pad is at least 0.25 mm, at least about 0.25 mm, at least 0.5 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 25 mm, at least 50 mm, at least 75 mm, at least 100 mm, at least 150 mm, at least 200 mm, at least 250 mm, at least 300 mm, at least 500 mm, at least 1000 mm, at least 5000 mm, or at least 10000 mm.

Embodiment 22: The friction pad, torque assembly, or method of any of embodiments 1-3, wherein an inner radius, IR_{F}, of the friction pad is at least about 0.25 mm, at least 0.5 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 25 mm, at least 50 mm, at least 75 mm, at least 100 mm, at least 150 mm, at least 200 mm, at least 250 mm, at least 300 mm, at least 500 mm, at least 1000 mm, at least 5000 mm, or at least 10000 mm.

Embodiment 23: The friction pad, torque assembly, or method of any of embodiments 1-3, wherein the plurality of grooves comprises a first groove shape and a second groove shape, wherein the first groove shape and the second groove shape are patterned alternatively around the circumference of at least one of the major surfaces of the friction pad body.

Embodiment 24: The friction pad, torque assembly, or method of any of embodiments 1-3, wherein the plurality of grooves comprises a first groove shape and a second groove shape, wherein at least two of the first groove shape or the second groove shape are patterned consecutively around the circumference of at least one of the major surfaces of the friction pad body.

Embodiment 25: The friction pad, torque assembly, or method of any of embodiments 1-3, wherein at least one of the plurality of grooves comprises an arcuate shape.

Embodiment 26: The friction pad, torque assembly, or method of any of embodiments 1-3, wherein at least one of the plurality of grooves comprises a rectilinear shape.

Embodiment 27: The friction pad, torque assembly, or method of any of embodiments 1-3, wherein at least one of the plurality of grooves comprises a polygonal.

Embodiment 28: The friction pad, torque assembly, or method of any of embodiments 1-3, wherein at least one of the plurality of grooves comprises a circular or semi-circular cross-sectional shape.

Embodiment 29: The friction pad, torque assembly, or method of any of embodiments 1-3, wherein at least one of the plurality of grooves comprises a figure eight cross-sectional shape.

Embodiment 30: The friction pad, torque assembly, or method of any of embodiments 1-3, wherein the low friction material comprises a polyketone, polyaramid, a thermoplastic polyimide, a polyetherimide, a polyphenylene sulfide, a polyethersulfone, a polysulfone, a polyphenylene sulfone, a polyamideimide, ultra high molecular weight polyethylene, a thermoplastic fluoropolymer, a polyamide, a polybenzimidazole, or any combination thereof.

Embodiment 31: The friction pad, torque assembly, or method of any of embodiments 1-3, wherein the low friction material comprises a fluoropolymer.

Embodiment 32: The friction pad, torque assembly, or method of any of embodiments 1-3, wherein the low friction material comprises polytetrafluoroethylene.

Embodiment 33: The friction pad, torque assembly, or method of any of embodiments 1-3, wherein the low friction material comprises PEEK.

Embodiment 34: The friction pad, torque assembly, or method of any of embodiments 1-3, wherein the friction pad body comprises a substrate and the low friction material is disposed upon the substrate.

Embodiment 35: The friction pad, torque assembly, or method of embodiment 34, wherein the substrate comprises a metal, polymer, or ceramic.

Embodiment 36: The friction pad, torque assembly, or method of embodiment 34, wherein the substrate includes iron, copper, titanium, tin, aluminum, magnesium, zinc, or an alloy thereof.

Embodiment 37: The friction pad, torque assembly, or method of embodiment 34, wherein the substrate comprises steel, spring steel, or stainless steel.

Embodiment 38: The friction pad, torque assembly, or method of any of embodiments 1-3, wherein the low friction material comprises asperities comprising a plurality of apexes and nadirs, wherein the low friction material has a root mean square gradient of less than 0.064, wherein the low friction material induces formation of a film when engaged in a rotational interface w/a neighboring component.

Embodiment 39: The torque assembly of embodiment 2 wherein the torque assembly comprises a spindle drive.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A friction pad comprising:
a friction pad body comprising an annular base defining an aperture down a central axis, and first and second opposing major surfaces, wherein the friction pad body comprises a low friction material, and wherein at least one of the major surfaces comprises a plurality of grooves adapted to retain lubricant.

2. A torque assembly comprising:
a housing comprising a base and a cap;
at least one rotator disposed within the housing; and
at least one friction pad disposed adjacent to a rotator, the friction pad comprising:
a friction pad body comprising an annular base defining an aperture down a central axis, and first and second opposing major surfaces, wherein the friction pad body comprises a low friction material, wherein at least one of the major surfaces comprises a plurality of grooves adapted to retain lubricant.

3. A method comprising:
providing a housing comprising a base and a cap;
providing at least one rotator disposed within the housing; and
providing at least one friction pad disposed adjacent to a rotator, the friction pad comprising:
a friction pad body comprising an annular base defining an aperture down a central axis, and first and second opposing major surfaces, wherein the friction pad body comprises a low friction material; and
rotating the at least one rotator to provide a torque assembly, wherein the torque assembly provides a frictional torque that varies by less than +/−20% from a baseline torque value over at least 1 million test cycles and over temperature range of −40 C to 80 C.

4. The friction pad of claim 1, wherein the friction pad body comprises a plurality of radial tabs extending from the annular base, the radial tabs terminating radially inwardly or radially outwardly and providing a peripheral surface.

5. The torque assembly of claim 2, wherein the torque assembly further comprises a spring component.

6. The torque assembly of claim 2, wherein the torque assembly comprises at least two rotators.

7. The torque assembly of claim 2, wherein the torque assembly comprises at least two friction pads.

8. The torque assembly of claim 2, wherein the torque assembly comprises at least three friction pads.

9. The friction pad of claim 1, wherein at least one of the plurality of grooves is disposed on an inner radius of at least one of the major surfaces of the friction pad body.

10. The friction pad of claim 1, wherein at least one of the plurality of grooves is disposed on an outer radius of at least one of the major surfaces of the friction pad body.

11. The friction pad of claim 1, wherein at least one of the plurality of grooves has a pocket depth of at least 0.05 mm.

12. The friction pad of claim 1, wherein the plurality of grooves account for at least 10% of the surface area of at least one of the major surfaces of the friction pad body.

13. The friction pad of claim 1, wherein the plurality of grooves comprises a first groove shape and a second groove shape, wherein the first groove shape and the second groove shape are patterned alternatively around the circumference of at least one of the major surfaces of the friction pad body.

14. The friction pad of claim 1, wherein the plurality of grooves comprises a first groove shape and a second groove shape, wherein at least two of the first groove shape or the second groove shape are patterned consecutively around the circumference of at least one of the major surfaces of the friction pad body.

15. The friction pad of claim 1, wherein at least one of the plurality of grooves comprises an arcuate shape.

16. The friction pad of claim 1, wherein at least one of the plurality of grooves comprises a rectilinear shape.

17. The friction pad of claim 1, wherein at least one of the plurality of grooves comprises a polygonal.

18. The friction pad of claim 1, wherein at least one of the plurality of grooves comprises a circular or semi-circular cross-sectional shape.

19. The friction pad of claim 1, wherein at least one of the plurality of grooves comprises a figure eight cross-sectional shape.

20. The friction pad of claim 1, wherein the low friction material comprises a polyketone, polyaramid, a thermoplastic polyimide, a polyetherimide, a polyphenylene sulfide, a polyethersulfone, a polysulfone, a polyphenylene sulfone, a polyamideimide, ultra high molecular weight polyethylene, a thermoplastic fluoropolymer, a polyamide, a polybenzimidazole, or any combination thereof.
